(19) United States
(12) Patent Application Publication
(10) Pub. No.: US 2014/0168033 A1
(43) Pub. Date: Jun. 19, 2014

(54) METHOD, DEVICE, AND SYSTEM FOR EXCHANGING INFORMATION

(71) Applicant: Tencent Technology (Shenzhen) Company Limited, Shenzhen (CN)

(72) Inventors: Feng ZOU, Shenzhen (CN); Jie ZHAO, Shenzhen (CN); Xi YAN, Shenzhen (CN)

(73) Assignee: TENCENT TECHNOLOGY (SHENZHEN) COMPANY LIMITED, Shenzhen (CN)

(21) Appl. No.: 13/974,713

(22) Filed: Aug. 23, 2013

(30) Foreign Application Priority Data
Aug. 24, 2012 (CN) 2012103057178

(51) Int. Cl. G06F 3/14; H04B 7/24

(52) U.S. Cl. CPC G06F 3/1462; H04B 7/24
USPC 345/2.3

(57) ABSTRACT

This disclosure relates to a method, device, and system for exchanging information. The information exchanging method includes: a mobile terminal establishing a communication link with a service device connected to a display device, the mobile terminal detecting whether it is in close proximity of the display device, if yes, transmitting a first command including information to the service device, the service device, after receiving the first command, transmitting a second command including the information to the display device, and the display device displaying the information after receiving the second command. This disclosure can simplify the interaction process between the mobile terminal and the server, reduce manual participation by the user, thus improving user experience.

### FIELD

This disclosure generally relates to the field of information exchanging, and in particular, to a method, device, and system for exchanging information.

### BACKGROUND

As smartphones, Personal Digital Assistants (PDAs), and other mobile terminals continue to gain popularity, their applications have also become more and more extensive. For example, a user can use a mobile terminal to transfer user information (e.g., picture, user name, and user ID) to a cloud, and then use a service device to download the user information from the cloud, to perform logging into a particular application program (e.g., a microblog or QQ by Tencent) on the service device.

However, the above-described interactions between the mobile terminal and the service device can be tedious and the user needs to manually participate in the process for a number of times, thus affecting the user experience.

### SUMMARY

The technical problems to be resolved by this disclosure is to provide an information exchanging method, device and system to simplify the interacting process between a mobile terminal and a service device, and to reduce manual participation by the user, and thereby improving user experience.

In a first aspect of the disclosure, an information exchanging method is provided. The method includes:

a mobile terminal establishing a communication link with a service device connected to a display device,

the mobile terminal detecting whether it is in close proximity of the display device, if yes, transmitting a first command comprising information to the service device,

the service device, after receiving the first command, transmitting a second command comprising the information to the display device, and

the display device displaying the information after receiving the second command.

In a second aspect, another information exchanging method is provided. The method includes:

a mobile terminal establishing a communication link with a service device connected to a display device, and

the mobile terminal detecting if it is in close proximity of the display device, if yes, transmitting a first command comprising information to the service device to trigger the service device to transmit a second command comprising the information to the display device to be displayed by the display device.

In a third aspect, another information exchanging method is provided. The method includes:

a service device connected to a display device establishing a communication link with a mobile terminal,

the service device receiving a first command comprising information transmitted from the mobile terminal, the first command transmitted after the mobile terminal detects that it is in close proximity of the service device, and

the service device transmitting a second command including the information to the display device for the display device to display the information.

In a fourth aspect, a non-transitory computer readable storage medium storing a program is provided. The program, when executed, can perform all the steps of the information exchanging method in the second aspect of the disclosure.

In a fifth aspect, a non-transitory computer readable storage medium storing a program is provided. The program, when executed, can perform all the steps of the information exchanging method in the third aspect of the disclosure.

In a sixth aspect, a mobile terminal is provided. The mobile terminal can include:

a first establishing module that establishes a communication link between the mobile terminal and a service device connected to a display device,

a detecting module that detects whether the mobile terminal is in close proximity of the display device, and

a first transmitting/receiving module that, when the detecting module detects the mobile terminal is in close proximity of the display device, transmits a first command comprising information to the service device to trigger the service device to transmit a second command comprising the information to the display device so that the display device can display the information.

In a seventh aspect, a service device is provided. The service device can be connected to a display device. The service device can include:

a second establishing module that establishes a communication link with a mobile terminal, and

a second transmitting/receiving module that receives a first command comprising information transmitted from the mobile terminal, the first command transmitted after the mobile terminal detects that it is in close proximity of the service device, and transmits a second command including the information to the display device for the display device to display the information.

In an eighth aspect, an information exchanging system is provided. The system can include a mobile terminal and a service device connected to a display device, wherein:

the mobile terminal comprises:

a first establishing module that establishes a communication link between the mobile terminal and the service device connected to the display device,

a detecting module that detects whether the mobile terminal is in close proximity of the display device,

a first transmitting/receiving module that, when the detecting module detects the mobile terminal is in close proximity of the display device, transmits a first command comprising information to the service device,

wherein the service device comprises:

a second establishing module that establishes a communication link with a mobile terminal,

a second transmitting/receiving module that receives a first command comprising information transmitted from the mobile terminal, and transmits a second command including the information to the display device, and

wherein the display device displays the information after receiving the second command.

In the embodiments of the disclosure, after a mobile terminal and a service device connected to a display device establish a communication link, the mobile terminal can detect whether it is in close proximity of the display device. Thus, the mobile terminal can transmit a first command including information directly to the service device. After receiving the first command transmitted by the mobile terminal, the service device can transmit a second command including the information to the display device. The display device can display the information after receiving the second command. As such, the embodiments can simplify the interacting process between the mobile terminal and the service device, reducing manual participation by the user, and improving user experience. In addition, by displaying the information transmitted by the mobile terminal on the display device, the interaction between the mobile terminal and the service device can be visual to some extent, thus making the interactions between the mobile terminal and the service device more vivid.

### BRIEF DESCRIPTION OF THE DRAWINGS

FIG. 1 is a flowchart illustrating the exemplary steps of an information exchanging method, according to a first embodiment of the disclosure.

FIG. 2 is a flowchart illustrating the exemplary steps of an information exchanging method, according to a second embodiment of the disclosure.

FIG. 3 is a diagram illustrates an exemplary human-computer interface including guide information, according to the second embodiment of the disclosure.

FIG. 4 is a flowchart illustrating the exemplary steps of an information exchanging method, according to a third embodiment of the disclosure.

FIG. 5 is a flowchart illustrating the exemplary steps of a method of detecting being in close proximity of a display device, according to the third embodiment of the disclosure.

FIG. 6 is a flowchart illustrating the exemplary steps of an information exchanging method, according to a fourth embodiment of the disclosure.

FIG. 7 is a front view of a mobile terminal being in close proximity of a display device, according to the fourth embodiment of the disclosure.

FIG. 8a is a side view of a mobile terminal being in close proximity of a display device, according to the fourth embodiment of the disclosure.

FIG. 8b illustrates information exchange, according to the fourth embodiment of the disclosure.

FIG. 9 is a block diagram illustrating the exemplary structure of a mobile terminal, according to a fifth embodiment of the disclosure.

FIG. 10 is a block diagram illustrating the exemplary structure of another mobile terminal, according to the fifth embodiment of the disclosure.

FIG. 11 is a block diagram illustrating the exemplary structure of another mobile terminal, according to the fifth embodiment of the disclosure.

FIG. 12 is a block diagram illustrating the exemplary structure of a service device, according to a six embodiment of the disclosure.

FIG. 13 is a block diagram illustrating the exemplary structure of an information exchanging system, according to a seventh embodiment of the disclosure.

FIG. 14 is a block diagram illustrating exemplary common components of a system that can be one of the terminals and/or servers of the embodiments of the disclosure.

### DETAILED DESCRIPTION

A detailed description of the technical solutions of the embodiments of the present disclosure is provided below in view of the accompanying drawings. It should be understood that the embodiments described below are representative embodiments of the present disclosure rather than a complete disclosure of the every possible embodiment. The present disclosure can also include any other embodiments that can be derived from these disclosed embodiments by a person with ordinary skill in the art without any additional inventive work. It is to be understood that other embodiments can be used and structural changes can be made without departing from the scope of the embodiments of this disclosure.

This generally relates to a method for exchanging information between two devices. As referred hereinafter, a device can be any electronic device capable of connecting to a network for transmitting and receiving data. Such device can include, but are not limited to, PCs, Macs, desktop computers, laptop computers, tablet PCs, smartphones including iPhones, Android phones, Windows phones, and Blackberries, e-readers, in-car communication devices, televisions and other consumer electronic devices with sufficient network capabilities. Furthermore, a device can also be referred to as a terminal (i.e., “device” and “terminal” are interchangeable terminologies). For example, a mobile terminal can be any mobile device such as a mobile phone or a tablet PC. In some embodiments, the mobile terminal can include a camera, a flash, and the necessary program to process image data. The camera can optionally include an adjustable lens. The mobile terminal can also optionally include an accelerometer.

As referred hereinafter, a service device (or server) can also be any electronic device capable of communicating with one or more other devices. A service device (or server) can be a desktop computer, laptop computer, or another mobile terminal. A service device (or server) can, but is not required to, perform one or more functions including, but not limited to, providing a network service, hosting network-based applications, routing information among other devices, and providing access to a network for other devices. In short, a service device (or server) can simply be another device capable of communicating with another device over a network. As described in the embodiments below, the service device can be connected to a display device (or display). The display device can be a part of the service device (e.g., the display of a laptop PC) or connected to the service device using a cable or a wireless connection. For example, the display device can be a monitor connected to a desktop PC.

The mobile terminal and the service device can be preferably connected via a wireless networks. A communication link can be established between the mobile terminal and the service device using any suitable means. In one embodiment, a link can be established by, for example, the mobile terminal reading a code (QR code) including connection information displayed on the display connected to the service device and using the connection information to establish a communication link with the service device. The connection information can be, for example, an IP address, Wi-Fi ID, or other types of identification information and/or network protocol information that may be required to establish the communication link.

In operation, information displayed on the mobile terminal can be transmitted in a visual way to the display connected to the server using embodiments of the disclosure. For example, the user may have the login information for an application (e.g., a microblog or QQ by Tencent) displayed on his smartphone. If he would like to have the same information automatically displayed on his laptop computer, using the disclosed methods, he can simply move the smartphone to close proximity of the display of the laptop computer. The smartphone can detect a distance between itself and the display of the laptop computer to determine if it is close enough to the display. This detection can be based on, for example, the brightness of a picture taken by the camera on the smartphone as it moves closer to the display of the laptop. Because the display of the laptop can be reflective, as the smartphone moves closer to the display, a picture taken by the camera on the smartphone can have a brightness exceeding a particular threshold.

As described in detail below, various mechanisms can also be used to indicate when the camera can take the picture to be used to determine whether the smartphone is in close proximity of the display. For example, if the smartphone is equipped with an accelerometer, an acceleration-to-deceleration motion captured by the accelerometer can be used as an indication that the mobile phone has been moved closer to the display and trigger the camera to take a picture. Alternatively, if the camera on the smartphone is equipped with an adjustable lens, if the lens is adjusting continuously to focus on an object, it can indicate that the smartphone is being moved closer to the display and that a picture can be taken to be used to determine whether the smartphone is close enough to the display.

After the smartphone determines that it is in close proximity of the display of the laptop, it can inform the laptop in this regard and the laptop can notify both the display and the smartphone to prepare for a data transfer. When both devices are set for the transfer, an animation can be initiated on the smartphone that shows the information being transferred (e.g., the user login information) being moving off the screen of the smartphone. As the information disappears on the screen of the smartphone, the same information can gradually appear on the display of the laptop to create a visual effect that the information is being moved from the smartphone to the laptop screen. As such, the user is no longer required to re-type the information on the laptop or transmit the information using email, instant messaging, or other messaging applications. All he needs to do is to move the smartphone closer to the display of the laptop and the information can be automatically transferred. This method of exchanging information between two devices can be used to transfer any suitable type of information, such as a web link, an email address, etc. The type of information being transferred is not limited to text information, but can also include other types of data, such as image, audio, and video data. Various embodiments of the disclosure are described in detail below in view of the figures.

The embodiments of the disclosure provide information exchanging methods, devices, and systems to simplify the interactions between a mobile device and a service device, reducing manual participation by the user, and improving user experience. Exemplary embodiments are described in detail below.

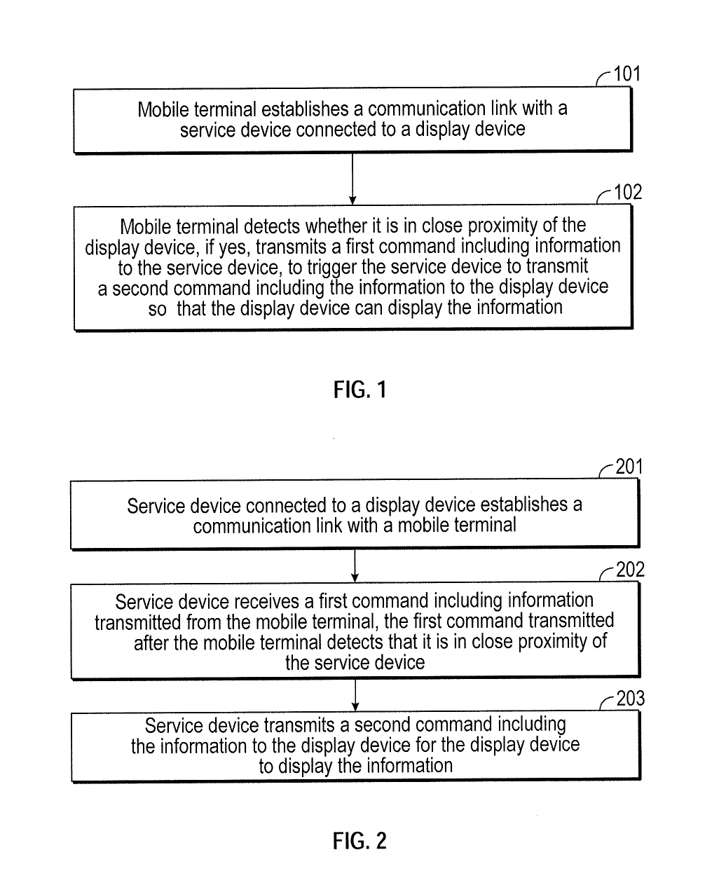

Referring to FIG. 1, FIG. 1 is a flowchart illustrating the exemplary steps of an information exchanging method, according to a first embodiment of the disclosure. The first embodiment is described from the mobile terminal's perspective. As illustrated in FIG. 1, the information exchanging method can include the following exemplary steps.

101. The mobile terminal can establish a communication link with a service device connected to a display device.

In the embodiments of the disclosure, a mobile terminal can be a smartphone, PDA, or any other touch screen equipped mobile terminal. Alternatively, it can also be other touch screen equipped mobile internet devices (MIDs).

In this embodiment, the display device connected to the service device can be a stand-alone display. Alternatively, the service device can be a smart terminal equipped with a display, such as a tablet PC, laptop PC, smart recharging terminal, smart trading terminal, etc.

In this embodiment, the service device can be a server, host computer, or other terminals providing external service capabilities.

Optionally, the mobile terminal can establish a communication link with the service device connected to the display device using the following exemplary steps.

Step 1: the mobile terminal can read a 2-dimensional code displayed on a human-computer interface of the display device connected to the service device.

Step 2: the mobile terminal can decode the 2-dimensional code to obtain transfer protocol information.

The mobile terminal can obtain Hypertext Transfer Protocol (HTTP) information or other transfer protocol information capable of establishing a communication link, after decoding the 2-dimensional code.

Step 3: the mobile terminal can transmit a communication link request to the service device in accordance with the transfer protocol information.

Step 4: the service device can return a response to the communication link request to the mobile terminal to establish the communication link between the mobile terminal and the service device.

In this embodiment, the mobile terminal can read the 2-dimensional code displayed on the human-computer interface of the display device connected to the service device and decode the transfer protocol information in the 2-dimensional code to establish a communication link with the service device, thus effectively improving the efficiency of establishing a communication link.

If the hardware of the mobile terminal and the service device has the capability, the communication link can be completed using near field communication technology.

102. The mobile terminal can detect whether it is in close proximity of the display device. If yes, it can transmit a first command including information to the service device, to trigger the service device to transmit a second command including the information to the display device so that the display device can display the information.

In this embodiment, the information in the first command can be user identity information needed to log into an application program (e.g., a microblog, QQ). The user identity information can include a picture, user name, and/or user ID. Alternatively, the information in the first command can be the data to be exchanged with the service device after the user successfully logs into the particular application program (e.g., microblog, QQ). Alternatively, the information in the first command can be a Uniform/Universal Resource Locator (URL) for visiting a particular network resource.

In this embodiment, after reading the 2-dimensional code displayed on the human-computer interface of the display device connected to the service device and decoding the 2-dimenstional code, the mobile terminal can obtain display device information. The information can include, for example, an ID or serial number of the display device. As such, the communication link request transmitted from the mobile terminal to the service device based on the transfer protocol information can include the display device information so that the service device can recognize the corresponding display device and transmit a second command including the information from the first command to the display device so that the corresponding display device can display this information. This method can allow the service device to accurately locate the display device in close proximity of the mobile device even when the service device is connected to multiple display devices. Thus, the service device can transmit the second command including the information from the first command to the display device in close proximity of the mobile terminal.

Optionally, the mobile terminal detecting whether it is in close proximity of the display device in step 102 can include the following exemplary steps.

Step 1: the mobile terminal can turn on a flash and capture image data, and perform pixel optimization on the image data to obtain an image.

In this embodiment, when the camera lens of the mobile terminal captures a designated image or a designated area in a particular color displayed on the human-computer interface of the display device, the mobile terminal can turn on the flash immediately and capture image data.

Step 2: the mobile terminal can determine whether a brightness of the image exceeds a predetermined threshold. If yes, it can determine that the mobile terminal is in close proximity of the display device.

In this embodiment, if the mobile terminal is in close proximity of the display device, the mobile terminal can turn on the flash and capture the image data. The brightness of the image obtained from performing pixel optimization on the image data can be greatly enhanced because of the reflective effect of the display of the display device. Thus, as long as the predetermined threshold is reasonably set and the brightness of the image is determined to be above the threshold, it can be determined that the mobile terminal is in close proximity of the display device.

Optionally, the mobile terminal detecting whether it is in close proximity of the display device of step 102 can include the following exemplary steps.

Step 1: the mobile terminal can capture a first image data and perform pixel optimization on the first image data to obtain a first image.

In this embodiment, when capturing a target image displayed on the human-computer interface of the display device, the mobile terminal can turn off the flash and capture a first image data, which can be the target image data, and perform pixel optimization on the first image data to obtain a first image.

Step 2: the mobile terminal can compare the first image with a predetermined target image to determine if they are the same. If yes, it can turn on the flash and capture a second image data and performing pixel optimization on the second image data to obtain a second image.

In this embodiment, a target image can be pre-stored at the mobile terminal. The target image can be a designated area of a display of the display device. For example, the target image can be the area of the display of the display device that displays the information in the second command transmitted by the service device.

After determining that the first image and the target image are the same, the mobile terminal can determine that it is facing the designated area of the display of the display device at that moment.

Step 3: the mobile terminal can determine whether a difference between a brightness of the first image and a brightness of the second image is above a predetermined threshold. If yes, it can determine that the mobile terminal is in close proximity of the display device.

If the mobile terminal is facing the designated area of the display of the display device and in close proximity of the display device, the mobile terminal can turn on the flash and capture a second image data. In addition, the brightness of the second image obtained from performing pixel optimization on the second image data can be greatly enhanced because of the reflective effect of the display of the display device. Thus, as long as the predetermined threshold is reasonably set and the difference in the brightness of the second image and the brightness of the first image is above the threshold, it can be determined that the mobile terminal is in close proximity of the display device.

Optionally, before capturing the first image data and performing pixel optimization on the first image data to obtain a first image, the mobile terminal can also perform the following step.

The mobile terminal can use an accelerometer to detect whether the mobile terminal produces an acceleration-to-deceleration action. If so, the mobile terminal can perform the above-described capturing the first image data and performing pixel optimization on the first image data to obtain a first image.

When the mobile terminal uses the accelerometer to detect that it has produced an acceleration-to-deceleration action, it can mean that the mobile terminal is gradually moving closer to the display device. In other words, in this embodiment, the mobile terminal can first use the accelerometer to detect that the mobile terminal has produced an acceleration-to-deceleration action, and then be triggered to detect if it is in close proximity of the display device.

Optionally, before capturing a first image data and performing pixel optimization on the first image data to obtain a first image, the mobile terminal can perform the following step.

The mobile terminal can detect whether a camera lens set to a continuous-focusing mode is focusing continuously. If so, the mobile terminal can perform the above-described capturing the first image data and performing pixel optimization on the first image data to obtain a first image.

When the mobile terminal detects a camera lens of the mobile terminal being set to a continuous-focusing mode is focusing continuously, it can mean that the mobile terminal is gradually moving closer to the display device. In other words, in this embodiment, the mobile terminal can first detect that a camera lens of the mobile terminal being set to a continuous-focusing mode is focusing continuously, and then be triggered to detect if it is in close proximity of the display device.

Based on the above description, the method illustrated in FIG. 1 can simplify the interaction process between the mobile terminal and the service device, reduce manual participation by the user, and thus improving user experience. In addition, in this embodiment, the information transmitted by the mobile terminal can be displayed by the display device. This can, to certain extent, visually present the interactions between the mobile terminal and the server, making the interactions between the mobile terminal and the server more vivid.

Referring to FIG. 2, FIG. 2 is a flowchart illustrating the exemplary steps of an information exchanging method, according to a second embodiment of the disclosure. The second embodiment is described from the perspective of the service device. As illustrated in FIG. 2, the information exchange method can include the following steps.

201: a service device connected to a display device can establish a communication link with a mobile terminal.

Optionally, the service device connected to a display device can establish a communication link with the mobile terminal via the following exemplary steps.

Step 1: the service device can receive a communication link request transmitted by the mobile terminal.

The communication link request transmitted by the mobile terminal can be a 2-dimensional code displayed on the human-computer interface of the display device connected to the service device. After decoding the 2-dimensional code to obtain the transfer protocol information, the request can be transmitted to the service device in accordance with the transfer protocol information.

Step 2: the service device can return a response to the communication link request to the mobile terminal to establish the communication link between the mobile terminal and the service device.

202: the service device can receive a first command including information transmitted from the mobile terminal, the first command transmitted after the mobile terminal detects that it is in close proximity of the service device.

203: the service device can transmit a second command including the information to the display device for the display device to display the information.

Optionally, after the service device connected to the display device establishes a communication link with the mobile terminal, the following steps can be performed.

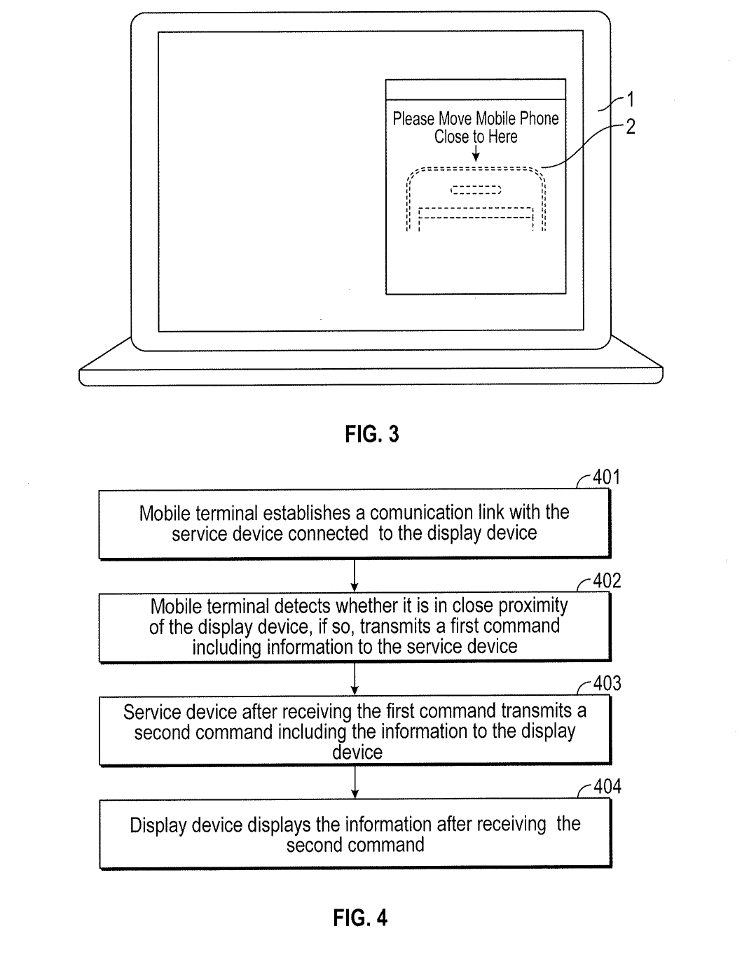

The service device can notify the display device to display guide information, which can guide the user to move the mobile terminal closer to an area of the display device for displaying information. For example, the guide information displayed on the display device can be, such as, “Please Move Mobile Phone Close to Here.” Using the human-computer interface of display device 1 to display the guide information “Please Move Mobile Phone Close to Here,” as illustrated in FIG. 3, as an example, the guide information “Please Move Mobile Phone Close to Here” can guide the user to put his mobile phone close to an area 2 for displaying user information (e.g., picture, username, and user ID) when logging into the use's QQ account. In this embodiment, the guide information displayed on the display device can enrich the visual interactive effects between the mobile terminal and the server device, thereby improving user experience.

Optionally, after the service device connected to the display device establishes a communication link with the mobile terminal and before the service device receives the first command including the information from the mobile terminal, the following exemplary steps can be performed.

Step 1: the service device can receive a notification transmitted by the mobile terminal. The notification can notify the service device that the mobile terminal has detected itself to be in close proximity of the display device.

Step 2: the service device can notify the display device that detection has completed and receive a notification from the display device regarding entering a set state.

Step 3: the service device can notify the mobile terminal to enter a set state.

In this embodiment, both the service device and the mobile terminal can enter into a set state, avoiding bringing any sudden changes to the operations of both devices.

Based on the above description, the method illustrated in FIG. 2 can simplify the interaction process between the mobile terminal and the server, reduce manual participation by the user, and thus improving user experience. In addition, in this embodiment, the information transmitted by the mobile terminal can be displayed by the display device. This can, to certain extent, visually present the interactions between the mobile terminal and the server, making the interactions between the mobile terminal and the server more vivid.

Referring to FIG. 4, FIG. 4 is a flowchart illustrating exemplary steps of an information exchanging method, according to a third embodiment of the disclosure. The third embodiment is described from the perspective of the mobile terminal and the service device connected to the display device. As illustrated in FIG. 4, the information exchanging method can include the following exemplary steps.

401: the mobile terminal can establish a communication link with the service device connected to the display device.

Step 401 can be implemented in the same way as step 101 in the previous embodiment.

402: the mobile terminal can detect whether it is in close proximity of the display device. If so, it can transmit a first command including information to the service device.

403: the service device, after receiving the first command, can transmit a second command including the information to the display device.

404: the display device can display the information after receiving the second command.

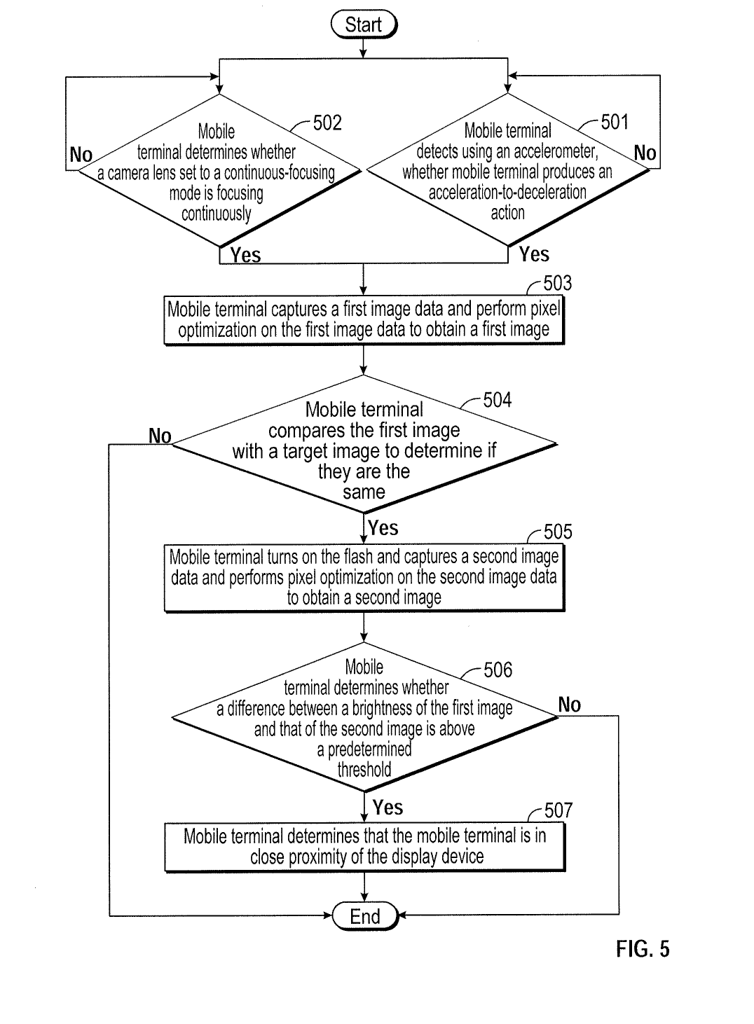

Optionally, the mobile terminal detecting whether it is in close proximity of the display device in Step 402 can be implemented using the method illustrated in FIG. 5. The method can include the following exemplary steps.

501: the mobile terminal can detect, using an accelerometer, whether the mobile terminal produces an acceleration-to-deceleration action. If yes, step 503 can be performed. If no, continue to perform step 501.

502: the mobile terminal can determine whether a camera lens set to a continuous-focusing mode is focusing continuously. If yes, step 503 can be performed. If no, continue to perform step 502.

It should be noted that the mobile terminal can elect to perform one of the above-described steps 501 and 502. Alternatively, the mobile terminal can perform both steps 501 and 502 described above. In particular, when the mobile terminal performs both steps 501 and 502, the order in which the steps are performed is not restricted.

503: the mobile terminal can capture a first image data and perform pixel optimization on the first image data to obtain a first image.

504: the mobile terminal can compare the first image with a target image to determine if they are the same. If yes, step 505 can be performed. If no, the process can end.

505: the mobile terminal can turn on the flash and capture a second image data and perform pixel optimization on the second image data to obtain a second image.

506: the mobile terminal can determine whether a difference between a brightness of the first image and a brightness of the second image is above a predetermined threshold. If yes, perform step 507. If no, the process can end.

507: the mobile terminal can determine that the mobile terminal is in close proximity of the display device.

In the information exchanging method illustrated in FIG. 4, after the mobile terminal detects that it is in close proximity of the display device and before transmitting the first command including information to the service device, the following steps can be performed.

Step 1: the mobile terminal can notify the service device regarding having detected itself being in close proximity of the display device.

Step 2: the service device can notify the display device that the detection has been completed and receive a notification returned from the display device regarding the display device entering a set state.

Step 3: the service device can notify the mobile terminal to enter a set state.

In the information exchanging method illustrated in FIG. 4, after the mobile terminal and the service device connected to the display device establish a communication link, the following steps can be performed.

The service device can notify the display device guide information for guiding a user to move the mobile device close to an information-displaying area of the display device.

Based on the above description, the method illustrated in FIG. 4 can simplify the interaction process between the mobile terminal and the server, reduce manual participation by the user, and thus improving user experience. In addition, in this embodiment, the information transmitted by the mobile terminal can be displayed by the display device. This can, to certain extent, visually present the interactions between the mobile terminal and the server, making the interactions between the mobile terminal and the server more vivid.

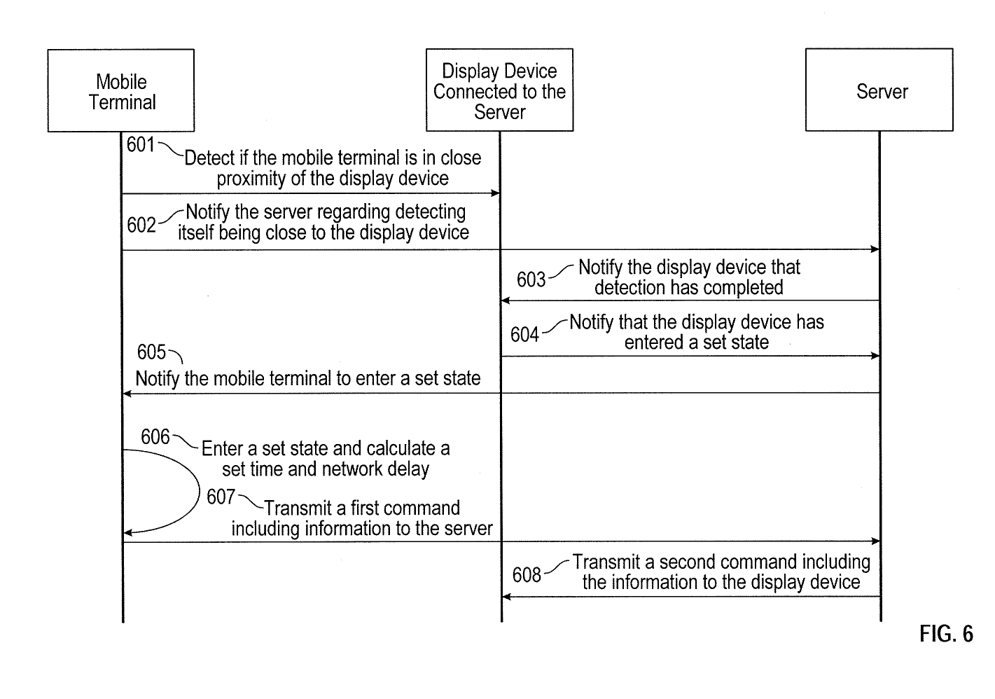

Referring to FIG. 6, FIG. 6 is a flowchart illustrating the exemplary process of an information exchanging method, according to a fourth embodiment of the disclosure. The fourth embodiment is described from the perspective of a mobile terminal and a server (e.g., a service device) connected to a display device. As illustrated in FIG. 6, the information exchanging method can include the following steps.

601: the mobile terminal can detect if it is in close proximity of the display device.

Exemplary implementations of the mobile terminal detecting itself being in close proximity of the display device have been discussed in detail in the previous embodiments and is be repeated here.

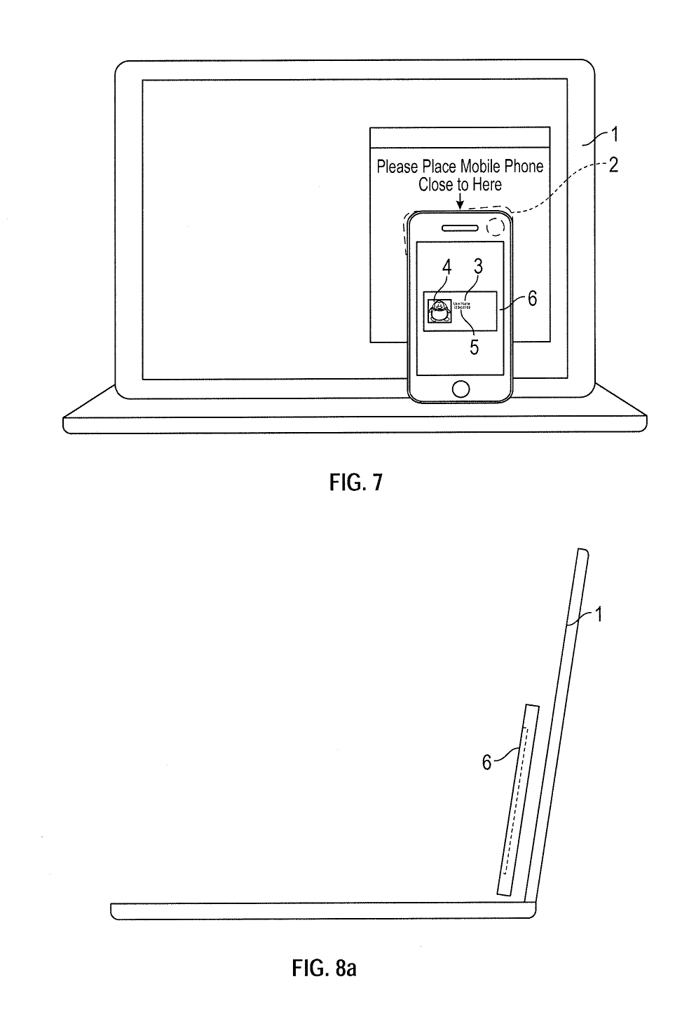

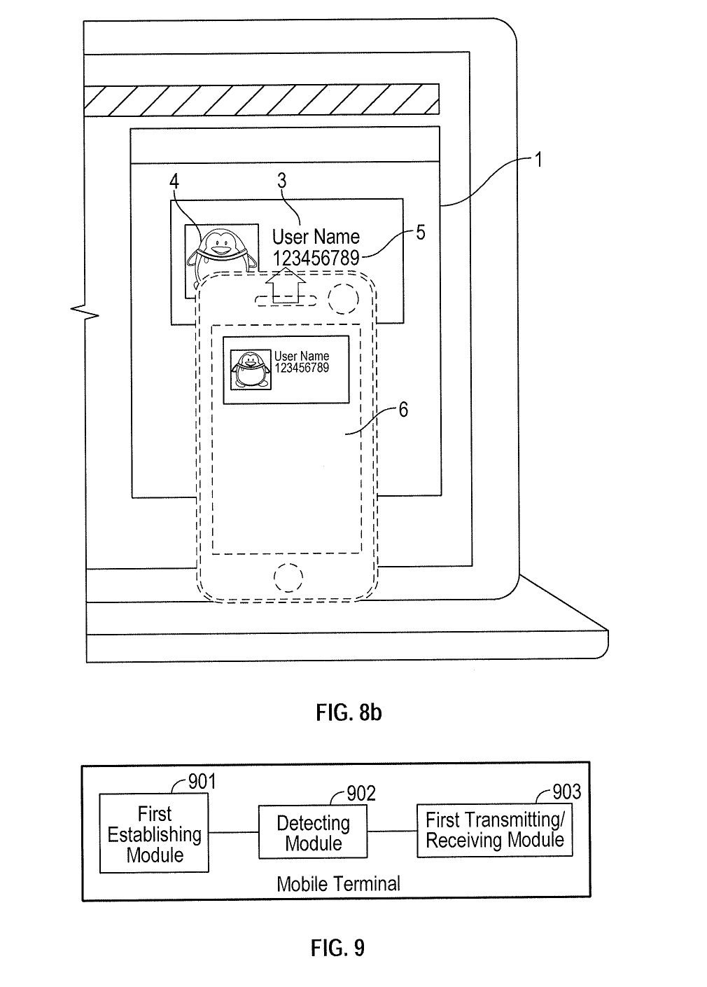

For example, a mobile terminal being in close proximity of a display device is illustrated in FIGS. 7 and 8a. FIG. 7 provides a front view illustrating a mobile terminal 6 being in close proximity of a display device 1. FIG. 8a is a side view illustrating the mobile terminal 6 being in close proximity of the display device 1. As illustrate in FIG. 7, the human-computer interface of display device 1 can include guide information “Please Place Mobile Phone Close to Here.” This guide information, “Please Place Mobile Phone Close to Here,” can guide the user to move the mobile terminal closer to area 2 of the display device 1 for displaying user information (e.g., picture 4, username 3, and user ID 5) when the user logs into QQ.

602: the mobile terminal can notify the server regarding detecting itself being close to the display device.

603: the server can notify the display device that detection has completed.

604: the server can receive a notification returned from the display device notifying that the display device has entered a set state.

605: the server can notify the mobile terminal to enter a set state.

606: the mobile terminal can enter a set state and calculate a set time and network delay.

607: the mobile terminal can transmit a first command including information to the server.

The information included in the first command transmitted by the mobile terminal can include user information (e.g., picture 4, username 3, and user ID 5) for logging into QQ.

608: after receiving the first command including the information transmitted from the mobile terminal, the server can transmit a second command including the information to the display device, to have the display device display the information.

As illustrated in FIG. 8b, in this embodiment, the user can use a finger to touch the user information on a touch screen of the mobile terminal 6 when logging into QQ and gently slide upwards to trigger the mobile terminal to transmit a first command including user information (e.g., picture 4, username 3, and user ID 5) for logging into QQ to the server. The user can touch the user information (e.g., picture 4, username 3, and user ID 5) for logging into QQ on the touch screen of the mobile terminal and slide gently upward to produce the visual effect of the user information (e.g., picture 4, username 3, and user ID 5) for logging into QQ being moved out of the mobile terminal. At the same time, the display device can display the user information (e.g., picture 4, username 3, and user ID 5) for logging into QQ, and thus providing the user a visual effect of moving information from the mobile terminal into the display device. This can further improve the visual effects of the interaction.

In this embodiment, the first command can be a synchronous animation starting instruction or another newly-added command. The second command can be an animation starting command or another newly-added command.

As such, the method illustrated in FIG. 6 can simplify the interaction process between the mobile terminal and the server, reduce manual participation by the user, and thus improving user experience. In addition, in this embodiment, the information transmitted by the mobile terminal can be displayed by the display device. This can, to certain extent, visually present the interactions between the mobile terminal and the server, making the interactions between the mobile terminal and the server more vivid.

Referring to FIG. 9, FIG. 9 is a block diagram illustrating the exemplary structure of a mobile terminal, according to a fifth embodiment of the disclosure. As illustrated in FIG. 9, the mobile terminal can include the following exemplary modules.

A first establishing module 901 that can establish a communication link between the mobile terminal and a service device connected to a display device.

A detecting module 902 that can detect whether the mobile terminal is in close proximity of the display device.

A first transmitting/receiving module 903 that, when the detecting module detects the mobile terminal is in close proximity of the display device, can transmit a first command including information to the service device to trigger the service device to transmit a second command including the information to the display device so that the display device can display the information.

Optionally, the first establishing module 901 can read the 2-dimensional code displayed on the human-computer interface of the display device connected to the service device and decode the 2-dimensional code to obtain the transfer protocol information. It can also transmit the communication link request to the service device in accordance with the transfer protocol information and receive a response to the communication link request from the service device, thereby establishing the communication link between the mobile terminal and the service device.

The transfer protocol information can be HTTP information.

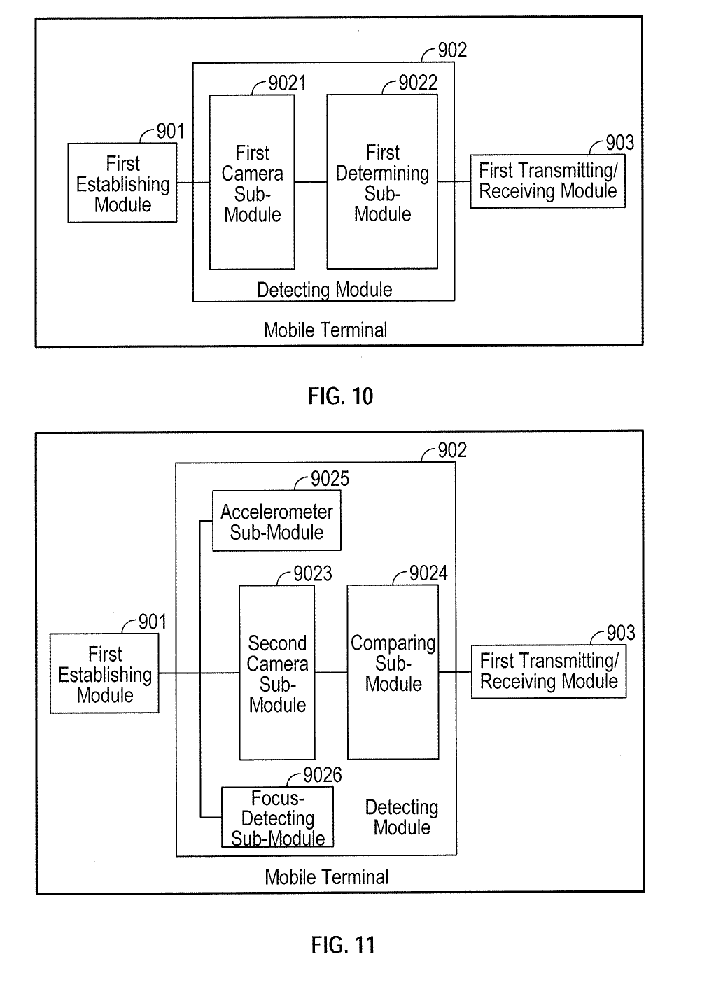

Referring to FIG. 10, FIG. 10 is a block diagram illustrating the exemplary structure of a mobile terminal, according to a fifth embodiment of the disclosure. The mobile terminal of FIG. 10 can be obtained by optimizing the mobile terminal of FIG. 9. In the mobile terminal of FIG. 10, the detecting module 902 can include the following modules:

A first camera sub-module 9021 that can turn on a flash and capture image data, and perform pixel optimization on the image data to obtain an image.

A first determining sub-module 9022 that can determine whether a brightness of the image exceeds a predetermined threshold, if yes, determine that the mobile terminal is in close proximity of the display device.

Referring to FIG. 11, FIG. 11 is a block diagram illustrating the exemplary modules of a mobile terminal, according to a fifth embodiment of the disclosure. The mobile terminal of FIG. 11 can be obtained by optimizing the mobile terminal of FIG. 9. In the mobile terminal of FIG. 11, the detecting module 902 can include the following modules.

A second camera sub-module 9023 that can capture a first image data and perform pixel optimization on the first image data to obtain a first image.

A comparing sub-module 9024 that can compares=the first image with a predetermined target image to determine if they are the same.

If the first image and the predetermined target image are determined to be the same, the above-described second camera sub-module 9023 can turn on the flash and capture a second image data and perform pixel optimization on the second image data to obtain a second image.

The above-described comparing sub-module 9024 can determine whether a difference between a brightness of the first image and a brightness of the second image is above a predetermined threshold. If yes, it can determine that the mobile terminal is in close proximity of the display device.

Optionally, in the mobile terminal of FIG. 11, the detecting module 902 can also include the following modules.

An accelerometer sub-module 9025 that can detect whether the mobile terminal produces an acceleration-to-deceleration action, if yes, triggers the second camera module to capture the first image data and perform pixel optimization on the first image data to obtain a first image.

Optionally, in the mobile terminal of FIG. 11, the detecting module 902 can also include the following modules.

A focus-detecting sub-unit 9026 that can detect whether a camera lens set to a continuous-focusing mode is focusing continuously, if yes, trigger the second camera sub-module to capture the first image data and perform pixel optimization on the first image data to obtain a first image.

In this embodiment, the detecting module 902 can be equipped with both the accelerometer sub-module 9025 and the focus-detecting sub-unit 9026 or one of these two modules.

In the mobile terminal of FIGS. 9-11, the first transmitting/receiving module 902 can, after the detecting module 902 detects that the mobile terminal is in close proximity of the display device and before transmitting the first command comprising information to the service device, notify the service device regarding having detected the mobile terminal being in close proximity of the display device, the service device receiving a notification returned from the display device regarding the display device entering a set state, and trigger the mobile terminal to enter in a set state after receiving from a notification transmitted from the service device.

As such, the mobile terminals illustrated in FIGS. 9-11 can simplify the interaction process between the mobile terminal and the server, reduces manual participation by the user, and thus improving user experience. In addition, in this embodiment, the information transmitted by the mobile terminal can be displayed by the display device. This can, to certain extent, visually present the interactions between the mobile terminal and the server, making the interactions between the mobile terminal and the server more vivid.

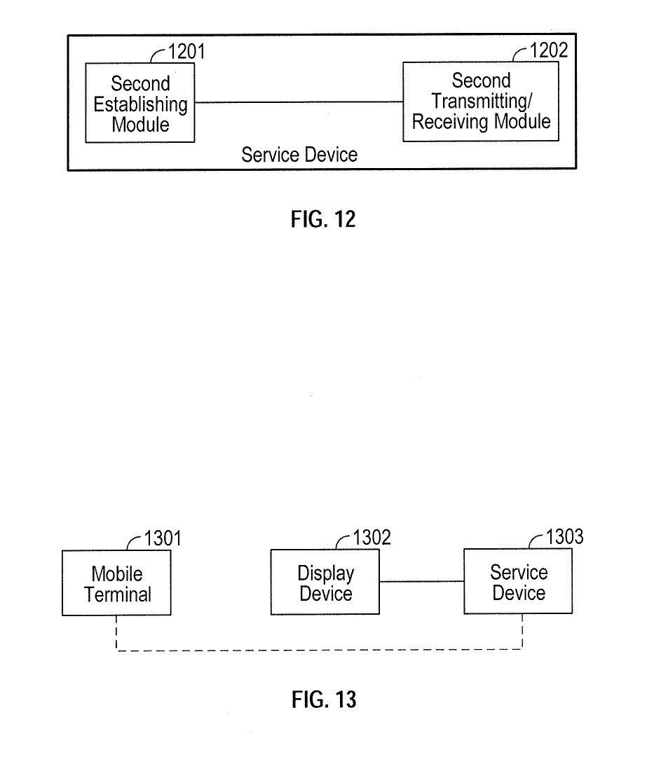

Referring to FIG. 12, FIG. 12 is a block diagram illustrating the exemplary structure of a service device, according to a sixth embodiment of the disclosure. The service device can be connected to a display device. As illustrated in FIG. 12, the service device can include the following exemplary modules.

A second establishing module 1201 that can establish a communication link with a mobile terminal.

A second transmitting/receiving module 1202 that can receive a first command including information transmitted from the mobile terminal, the first command transmitted after the mobile terminal detects that it is in close proximity of the service device, and transmit a second command including the information to the display device for the display device to display the information.

The second establishing module 1201 can receive the communication link request transmitted by the mobile terminal and return a respond to the communication link request to the mobile terminal to establish the communication link between the mobile terminal and the service device. The communication link request transmitted by the mobile terminal can be the mobile terminal reading a 2-dimensional code displayed on the human-computer interface of the display device connected to the service device. After the 2-dimensional code is decoded to obtain transfer protocol information, the transfer protocol information can be transmitted to the service device.

Optionally, the second transmitting/receiving module 1202 can, after the second establishing module establishes a communication link with the mobile terminal, notify the display device to display guide information, the guide information for guiding a user to move the mobile device close to an information-displaying area of the display device.

Optionally, the second transmitting/receiving module 1202 can, after the second establishing module establishes the communication link with the mobile terminal and before receiving the first command comprising the information from the mobile terminal, receive a notification transmitted by the mobile terminal, the notification notifying that the service device the mobile terminal has detected itself to be in close proximity of the display device, notify the display device that detection has completed, trigger the service device to enter into a set state after receiving a notification from the display device, and notify the mobile terminal to enter a set state.

As such, the service devices illustrated in FIG. 12 can simplify the interaction process between the mobile terminal and the server, reduce manual participation by the user, and thus improving user experience. In addition, in this embodiment, the information transmitted by the mobile terminal can be displayed by the display device. This can, to certain extent, visually present the interactions between the mobile terminal and the server, making the interactions between the mobile terminal and the server more vivid.

Referring to FIG. 13, FIG. 13 is a block diagram illustrating the exemplary structure of an information exchanging system, according to a seventh embodiment of the disclosure. As illustrated in FIG. 13, the information exchanging system can include a mobile terminal 1301 and a service device 1303 connected to a display device 1302. In the information exchanging system of FIG. 13, the structure and function of the mobile terminal 1301 can be the same as the structure and function of the mobile terminal of any of FIGS. 9-11. The structure and function of the service device 1303 can be the same as the structure and function of the service device of FIG. 12. The dotted lines represent that the mobile terminal 1301 is linked to the service device 1303 in a wireless manner.

As such, the information exchanging system illustrated in FIG. 13 can simplify the interaction process between the mobile terminal and the server, reduce manual participation by the user, and thus improving user experience. In addition, in this embodiment, the information transmitted by the mobile terminal can be displayed by the display device. This can, to certain extent, visually present the interactions between the mobile terminal and the server, making the interactions between the mobile terminal and the server more vivid.

Based on the above-described embodiments, a person skilled in the art can understand that parts of or the whole process described in each of the above embodiments can be performed by hardware in accordance with instructions from one or more computer programs. The one or more computer programs can be stored in a non-transitory readable medium, and when executed, perform the processes described in these embodiments. The non-transitory computer readable medium can be a floppy disk, CD, read-only memory (ROM), or random access memory (RAM).

In some embodiments, one or more of the modules and/or sub-modules in FIGS. 9-12 can be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this file, a “non-transitory computer-readable storage medium” can be any medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

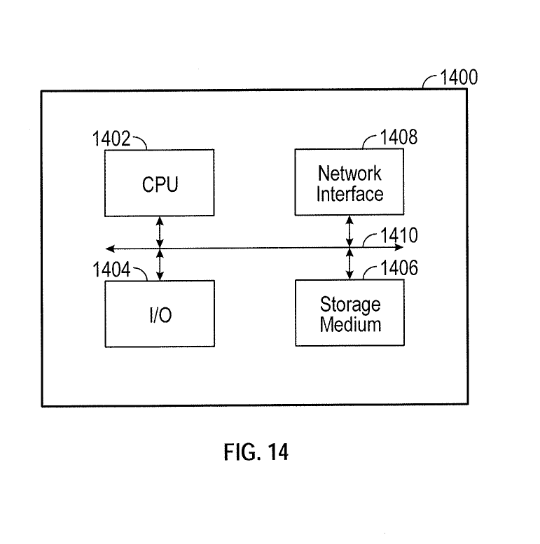

The non-transitory computer readable storage medium can be part of a computing system serving as the service device (e.g., server) or the mobile terminal. FIG. 14 illustrates exemplary common components of one such computing system. As illustrated, the system 1400 can include a central processing unit (CPU) 1402, I/O components 1404 including, but not limited to one or more of display, keypad, touch screen, speaker, and microphone, storage medium 1406 such as the ones listed in the last paragraph, and network interface 1408, all of which can be connected to each other via a system bus 1410. The storage medium 1406 can include one or more of the modules and/or sub-modules of FIGS. 9-12 depending on whether the system is a mobile terminal or a service device.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. An information exchanging method performed by a mobile terminal, comprising:
establishing a communication link with a service device connected to a display device, and
detecting if it is in close proximity of the display device, if yes, transmitting a first command comprising information to the service device to trigger the service device to transmit a second command comprising the information to the display device to be displayed by the display device.

2. The method of claim 1, wherein detecting if it is in close proximity of the display device comprises:
turning on a flash and capturing image data, and performing pixel optimization on the image data to obtain an image, and
determining whether a brightness of the image exceeds a predetermined threshold, if yes, determining that the mobile terminal is in close proximity of the display device.

3. The method of claim 1, wherein detecting if it is in close proximity of the display device comprises:
capturing a first image data and performing pixel optimization on the first image data to obtain a first image,
comparing the first image with a predetermined target image to determine if they are the same, if yes, turning on a flash and capturing a second image data and performing pixel optimization on the second image data to obtain a second image, and
determining whether a difference between a brightness of the first image and a brightness of the second image is above a predetermined threshold, if yes, determining that the mobile terminal is in close proximity of the display device.

4. The method of claim 3, wherein capturing a first image data and performing pixel optimization on the first image data to obtain a first image comprises:
detecting, using an accelerometer, whether the mobile terminal produces an acceleration-to-deceleration action, if yes, performing the step of capturing the first image data and performing pixel optimization on the first image data to obtain a first image, or
determining whether a camera lens set to a continuous-focusing mode is focusing continuously, if yes, performing the step of capturing the first image data and performing pixel optimization on the first image data to obtain a first image.

5. An information exchanging method performed by a service device connected to a display device, comprising:
establishing a communication link with a mobile terminal,
receiving a first command comprising information transmitted from the mobile terminal, the first command transmitted after the mobile terminal detects that it is in close proximity of the service device, and
transmitting a second command including the information to the display device for the display device to display the information.

6. The method of claim 5, comprising, after establishing the communication link with the mobile terminal,
notifying the display device to display guide information, the guide information for guiding a user to move the mobile device close to an information-displaying area of the display device.

7. The method of claim 5, comprising: after establishing a communication link with the mobile terminal and before receiving the first command comprising the information from the mobile terminal,
receiving a notification transmitted by the mobile terminal, the notification notifying the service device that the mobile terminal has detected itself to be in close proximity of the display device,
notifying the display device that detection has completed and receiving a notification from the display device regarding the display device entering a set state, and
notifying the mobile terminal to enter a set state.

8. A mobile terminal, comprising:
a first establishing module that establishes a communication link between the mobile terminal and a service device connected to a display device,
a detecting module that detects whether the mobile terminal is in close proximity of the display device, and
a first transmitting/receiving module that, when the detecting module detects the mobile terminal is in close proximity of the display device, transmits a first command comprising information to the service device to trigger the service device to transmit a second command comprising the information to the display device so that the display device can display the information.

9. The mobile terminal of claim 8, wherein the detecting module comprises:
a first camera sub-module that turns on a flash and captures image data, and performs pixel optimization on the image data to obtain an image, and
a first determining sub-module that determines whether a brightness of the image exceeds a predetermined threshold, if yes, determines that the mobile terminal is in close proximity of the display device.

10. The mobile terminal of claim 8, wherein the detecting module comprises:
a second camera sub-module that captures a first image data and performs pixel optimization on the first image data to obtain a first image, and
a comparing sub-module that compares the first image with a predetermined target image to determine if they are the same,
wherein the second camera sub-module that, if the first image and the predetermined target image are determined to be the same, turns on the flash and captures a second image data and performs pixel optimization on the second image data to obtain a second image, and
wherein the comparing sub-module determines whether a difference between a brightness of the first image and a brightness of the second image is above a predetermined threshold, if yes, determines that the mobile terminal is in close proximity of the display device.

11. The mobile terminal of claim 10, wherein the detecting module comprises:
an accelerometer sub-module that detects whether the mobile terminal produces an acceleration-to-deceleration action, if yes, triggers the second camera module to capture the first image data and perform pixel optimization on the first image data to obtain a first image, or
a focus-detecting sub-unit that detects whether a camera lens set to a continuous-focusing mode is focusing continuously, if yes, triggers the second camera sub-module to capture the first image data and perform pixel optimization on the first image data to obtain a first image.

12. The mobile terminal of claim 8, wherein
the first transmitting/receiving module, after the detecting module detects that the mobile terminal is in close proximity of the display device and before transmitting the first command comprising information to the service device, notifies the service device regarding having detected the mobile terminal being in close proximity of the display device, the service device receiving a notification returned from the display device regarding the display device entering a set state, and triggers the mobile terminal to enter in a set state after receiving the notification transmitted from the service device.

13. A service device connected to a display device, the service device comprising:
a second establishing module that establishes a communication link with a mobile terminal, and
a second transmitting/receiving module that receives a first command comprising information transmitted from the mobile terminal, the first command transmitted after the mobile terminal detects that it is in close proximity of the service device, and transmits a second command including the information to the display device for the display device to display the information.

14. The service device of claim 13, wherein,
the second transmitting/receiving module that, after the second establishing module establishes a communication link with the mobile terminal, notifies the display device to display guide information, the guide information for guiding a user to move the mobile device close to an information-displaying area of the display device.

15. The service device of claim 13, wherein,
The second transmitting/receiving module that, after the second establishing module establishes the communication link with the mobile terminal and before receiving the first command comprising the information from the mobile terminal, receives a notification transmitted by the mobile terminal, the notification notifying that the service device that the mobile terminal has detected itself to be in close proximity of the display device, notifies the display device that detection has completed, triggers the service device to enter into a set state after receiving the notification from the display device, and notifies the mobile terminal to enter a set state.

16. A non-transitory computer-readable medium of a mobile terminal, the medium storing a program which, when executed by a processor, performs the steps of:
establishing a communication link with a service device connected to a display device, and
detecting if it is in close proximity of the display device, if yes, transmitting a first command comprising information to the service device to trigger the service device to transmit a second command comprising the information to the display device to be displayed by the display device.

17. The non-transitory computer-readable medium of claim 16, wherein detecting if the mobile terminal is in close proximity of the display device comprises:
turning on a flash and capturing image data, and performing pixel optimization on the image data to obtain an image, and
determining whether a brightness of the image exceeds a predetermined threshold, if yes, determining that the mobile terminal is in close proximity of the display device.

18. The non-transitory computer-readable medium of claim 16, wherein detecting if the mobile terminal is in close proximity of the display device comprises:
capturing a first image data and performing pixel optimization on the first image data to obtain a first image,
comparing the first image with a predetermined target image to determine if they are the same, if yes, turning on a flash and capturing a second image data and performing pixel optimization on the second image data to obtain a second image, and
determining whether a difference between a brightness of the first image and a brightness of the second image is above a predetermined threshold, if yes, determining that the mobile terminal is in close proximity of the display device.

19. A non-transitory computer-readable medium of a service device, the medium storing a program which, when executed by a processor, performs the steps of:
establishing a communication link with a mobile terminal,
receiving a first command comprising information transmitted from the mobile terminal, the first command transmitted after the mobile terminal detects that it is in close proximity of the service device, and
transmitting a second command including the information to the display device for the display device to display the information.

20. The non-transitory computer-readable medium of claim 19, wherein the program which, when executed by a processor, performs the steps of: after establishing the communication link with the mobile terminal,
notifying the display device to display guide information, the guide information for guiding a user to move the mobile device close to an information-displaying area of the display device.

21. The non-transitory computer-readable medium of claim 19, wherein the program which, when executed by a processor, performs the steps of: after establishing a communication link with the mobile terminal and before receiving the first command comprising the information from the mobile terminal,
receiving a notification transmitted by the mobile terminal, the notification notifying the service device that the mobile terminal has detected itself to be in close proximity of the display device,
notifying the display device that detection has completed and receiving a notification from the display device regarding the display device entering a set state, and
notifying the mobile terminal to enter a set state.

22. A mobile terminal comprising:
a network interface that connects the mobile terminal via a communication link to a server comprising a display,
a camera that captures image data, and
a processor that processes the image data captured by the camera to determine if the mobile terminal is in close proximity of the display of the server, and transmits a first command via the communication link to the server when it determines that the mobile terminal is in close proximity of the display.

23. The mobile terminal of claim 22, comprising:
a flash that is turned on before the image data is captured, and
a memory unit that stores a program which, when executed by the processor, performs the steps of:
performing pixel optimization on the image data to obtain an image,
determining whether a brightness of the image exceeds a predetermined threshold,
if the brightness exceeds the predetermined threshold, determine that the mobile terminal is in close proximity of the display.

24. The mobile terminal of claim 22, comprising:
a flash, and
a memory unit that stores a program which, when executed by the processor, performs the steps of:
performing pixel optimization on the image data to obtain a first image,
comparing the first image with a pre-stored image to determine if they are the same,
if the first image and the pre-stored image are the same, turning on the flash and performing pixel optimization on a second image captured by the camera, and
determining whether a difference in a brightness of the first image and a brightness of the second image exceeds a predetermined threshold, and
if the brightness exceeds the predetermined threshold, determine that the mobile terminal is in close proximity of the display.

25. A server comprising:
a processor,
a display,
a network interface that connects the server via a communication link to a mobile terminal,
a memory unit that stores a program which, when executed by the processor, performs the steps of:
notifying the display to display guide information, the guide information for guiding the mobile device to be closer to an information-displaying area of the display,
receiving a notification transmitted by the mobile terminal, the notification notifying the server that the mobile terminal has detected itself to be in close proximity of the display,
notifying the display that the mobile terminal is in close proximity of the display,
receiving a notification from the display that the display has entering a set state,
notifying the mobile terminal to enter a set state, and
forwarding information received from the mobile terminal to the display to be displayed.
